(19) United States
(12) Patent Application Publication
(10) Pub. No.: US 2015/0356883 A1
(43) Pub. Date: Dec. 10, 2015

(54) TACTILE INPUT FOR IMPROVING PHYSICAL MOVEMENT

(71) Applicant: Erin McGuire, Los Angeles, CA (US)

(72) Inventor: Erin McGuire, Los Angeles, CA (US)

(21) Appl. No.: 14/298,367

(22) Filed: Jun. 6, 2014

(51) Int. Cl. G09B 19/00; G09B 5/00

(52) U.S. Cl. CPC G09B 19/003; G09B 5/00

(57) ABSTRACT

A system for providing tactile input for prompting a person to coordinate appropriate muscle contractions during some form of physical movement such as exercising. The system may comprise a belt bearing inwardly facing projections adapted to contact contracting muscles. The user may then be prompted by direct tactile feedback or by audible, visible, or vibratory outputs to facilitate proper contractions, timing, and sequencing of activities, as may be appropriate given the type of physical activity. The projections are blunt, being hemispherical, for example. The belt may include the projections, or alternatively, the projections may be attachable to a pre-existing belt. The projections may include transducers for providing signals to generate the audible, visible, or vibratory outputs. Outputs may be reproduced on a mobile communications device.

### FIELD OF THE INVENTION

The present invention relates to the human body for the purpose of providing a means to improve movement, exercising and the like. More specifically, the disclosure describes a belt having inwardly facing projections intended to provide tactile sensations which allow the user to improve the quality of muscle activity and contraction during physical movement.

### BACKGROUND OF THE INVENTION

All purposeful movement requires proper coordination and stability patterns. This applies to everyday activities such as walking, bending, reaching, etc, to exercising and high level sports activities. These patterns are driven by our nervous system and include proper coordination, timing and contraction of our neuromuscular system. These patterns need to be coordinated in order for us to support our bodies and create power and strength. Adoption of faulty patterns, or impaired coordination and quality of muscle activity, often occur for many reasons. Faulty patterns create excessive load on musculoskeletal structures and can lead to pain, injury and impaired performance.

Exercises have been developed to target specific muscles and/or muscle groups with the intention of providing rehabilitation, living a healthier lifestyle, and improving strength. One limitation to exercising is that the intended muscles may or may not be activated as intended by any given exercise. Many exercises directed to strengthening the abdominal muscles of the trunk region are not focused on aspects such as coordination and timing of the contractions of the abdominal and trunk musculature. As a result, the true benefit of the exercises is not realized. For example, a pattern of excessive activity of the upper portion of the rectus abdominus and over activity of the lumbar and lower thoracic paraspinal muscles is a faulty pattern often adopted and creates compressive load on the spinal structures. In addition, this pattern negatively effects strength and power production of the entire body. This proper pattern of trunk stabilization is a key factor for the integration of all movement within our nervous system and allows for improved movement and strength of our arms and legs.

A pattern adopted by a person while they perform daily activities, play sports, lift, exercise, etc is ingrained in the nervous system and is automatic. If improper, a person will need to relearn the pattern to correctly contract and coordinate the muscles involved, such as the trunk muscles. This re-education requires specific input and facilitation to be provided so that the person will be able to retrain the faulty patterns that have become ingrained by being able to feel the correct movement or muscle contraction.

One way to do this is to use the fingers, either of the person or of a physical therapist. The fingers pressing upon a particular muscle provide tactile input to assist the person in properly activating the intended muscle/muscle group, for example trunk contractions, thereby facilitating proper trunk stabilization. There exists a need for facilitating proper muscle contractions during any movement or activity to provide guidance assuring and improving appropriate contraction patterns.

### SUMMARY OF THE INVENTION

The present invention addresses the above stated situation by providing a belt for the torso, adapted to generate tactile input. The tactile input supplies the cue for the person wearing the belt to contract or tighten into. The belt includes inwardly facing projections which contact abdominal, or other muscles through the skin.

This replaces the user's fingers or the therapist's fingers. Tactile input arising from the inwardly facing projections are used as cues and provide the user with feedback to improve their sense/awareness of the intended muscle group to be contracted and facilitates improved quality of that contraction. In some implementations, there can be an ability of the inwardly facing projection to generate audible and/or visible advisory, or vibrational outputs if the person is correctly contracting the intended muscles. For example, as the person is able to increase the intensity of the muscle contraction, an audible beep can be heard getting louder as the contraction intensifies. Another implementation can be predetermined intervals of vibratory outputs. For example, vibration signals can be used every 2 minutes as reminders for an individual to actively tighten into the belt when using it for activities of longer duration

In some implementations, cues issued by transducers incorporated in the projections may be transmitted to mobile communications devices.

In an implementation, the projections which may or may not generate electrical signals may be provided for retrofitting to pre-existing belts.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a perspective view of apparatus for providing sensible input, according to at least one aspect of the invention;

FIG. 2 is an electrical schematic of circuitry which may be associated with the belt of FIG. 1;

FIG. 3 is a perspective view of an alternative apparatus for providing sensible input, according to a further aspect of the invention; and

FIG. 4 is a block diagram summarizing steps of a method of providing sensible input, according to at least one aspect of the invention.

### DETAILED DESCRIPTION

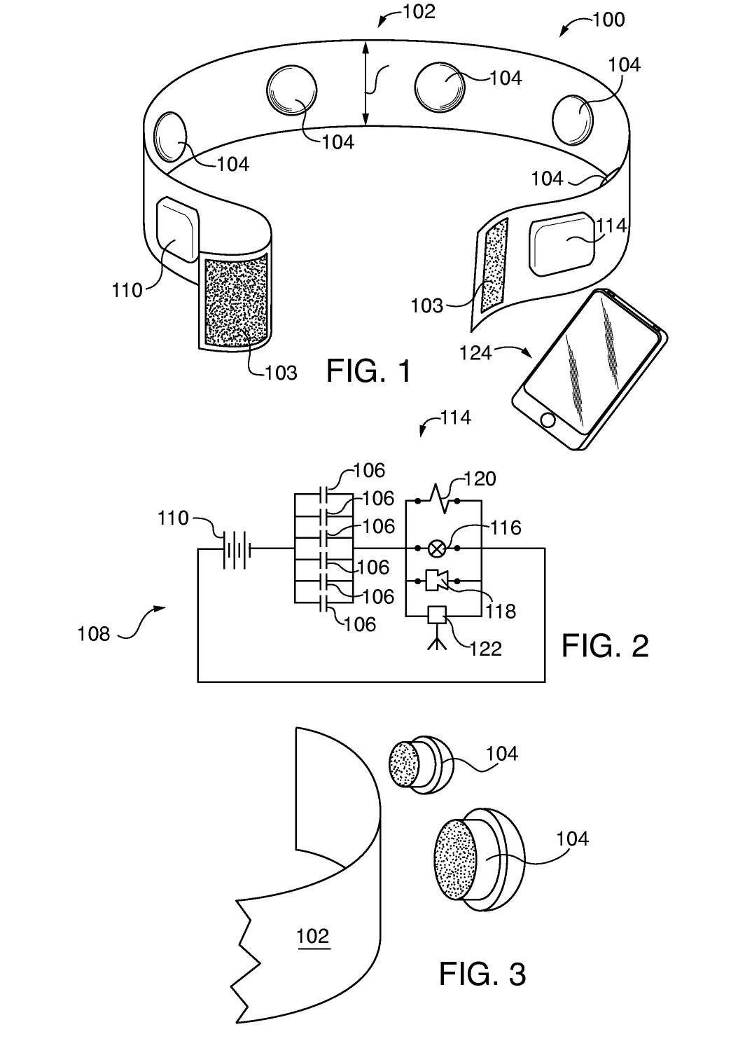

Referring first to FIGS. 1 and 2, according to at least one aspect of the invention, there is shown an apparatus 100 for providing sensible input to enable a person to control and improve contraction of muscles during daily activities, including exercising. The apparatus 100 is associated with a belt 102 worn around the body (not shown). The apparatus 100 includes a plurality of projections 104 associated with the belt 102. The projections 104 may each be blunt, for example, being substantially semispherical as depicted, or other. The projections 104 may each comprise a single resilient or elastic member, or alternatively, may comprise two or more mutually movable parts arranged to slide along one another.

The belt 102 may be elastic and resilient, having a width 112 of about two to eight inches, and sufficient length to entirely encircle the body. That part of the body which may be encircled may be an arm or leg, the trunk, or the hips. The belt 102 may encircle the abdominal area for facilitation, at any point from just below the ilium up to the lowermost three or four non-floating ribs. Alternatively, the belt 102 may be placed elsewhere for facilitating, for example, the gluteal muscles, trapezius muscles, the quads, and the medial gastrocnemius. The length of the belt 102 will be determined accordingly, and may be adjustable if desired to accommodate encircling all of the possible parts of the body where there is a need to improve muscle contraction. Fastening and adjustment of length of the belt 102 may be performed by hook and loop fastener 103, or by any other suitable arrangement of fasteners (none shown).

In an alternative embodiment, each one of the projections 104 may include a transducer 106 (FIG. 2) arranged to generate a signal when the muscles contract. In this embodiment the apparatus 100 includes an electrically powered signaling device 114, and a power circuit 108 (FIG. 2) including a power source 110 operably connecting each one of the projections 104 to the electrically powered signaling device 106. Electrical conductors of the power circuit 108 may be protectively contained and concealed within the belt 102. As depicted, the transducer 106 may comprise a pair of normally open contacts which close when a predetermined level of pressure is exerted on the belt projections by distension of the muscles. Alternatively, the transducer 106 may comprise a piezoelectric device, a pneumatic or hydraulic bulb arranged to transmit a pressure signal (none of these options are shown).

In either case when the belt 102 includes projections which may or may not include a transducer, the projections 104 may be detachably fixed to the belt 102 by hook and loop material or by any suitable fastener (these options are not shown). The projections 104 may be movably secured to the belt 102, for example, mounted on a loop that encircles the belt 102 and slides therealong (the arrangement including the loop is not shown) and/or held in pouches or pockets that are attached along the length of the belt. Regardless of the nature of the mounting of the projections 104, they may be adjustably positioned along the belt 102 to achieve optimum response of the muscle activity and if present, the transducers 106, allowing for best accommodation to different body dimensions and configurations given individual anatomical variation.

The projections 104 may be provided in different dimensions and different degrees of resistance to compression in order to accommodate the sensitivity and anatomical variations of the individual person. The degree of resistance to compression, which may be determined e.g. by projections 104 of different elastomeric composition, or in the case of multipart projections 104, by e.g. internal springs (not shown) of different spring or density characteristics, will be perceived by the user as variable firmness.

It is also contemplated that the belt 102 may include straps that can be used to maintain the belt about the body when not fully engaged. For example, back support belts, as used by various personnel during lifting activities, often include shoulder straps that are used to maintain the belt upon the body when the support belt is not engaged around the trunk. Such straps could be employed in the present invention as well.

Referring particularly to FIG. 2, the electrically powered signaling device 114 may be an indicating lamp 116 which produces a visible signal, a buzzer 118 or another type of sound producing device which produces a an audible signal, a vibratory device comprising for example an oscillating solenoid 120 which produces a vibratory signal, or a radio frequency transmitter 122. The electrically powered signaling device 114 may include more than one of the electrically powered signaling devices 114, including any combination of the listed types of electrically powered signaling devices 114.

The electrically powered signaling device 114 including the radio frequency transmitter 122 may operate in conjunction with a mobile communications device 124. The radio frequency transmitter 122 is in communication with each one of the transducers 106, being energized for example by closure of any one or more of the normally open contacts of the transducers 106. The radio frequency transmitter 122 operates at a frequency to which the mobile communications device 124 is responsive. The specific type of mobile communications device 124 will be understood to include a data processor, a display in communication with the data processor, a memory in communication with the data processor, and computer instructions loaded into the memory and operable to generate an output on the display which output is indicative of at least one muscle actuating at least one of the transducers 106. An iPhone RTM may be utilized as the mobile communications device 124, when a suitable application has been downloaded thereonto. The application drives the display of the iPhone responsively to receiving a radio frequency signal ultimately generated by closure of the normally open contacts of at least one transducer 106.

Any of the electrically powered signaling devices 114 may be separate from the belt 102, as occurs with the mobile communications device 124. For example, the buzzer 118 or the oscillating solenoid 120 may be arranged for mounting on the head or arm of the user. To accommodate this option, the apparatus 100 is provided with suitable signaling apparatus, such as using the Bluetooth protocol or any other low powered system (none shown), and separate power sources 110 distributed among the separated components, where necessary.

Turning to FIG. 3, in another implementation of the invention, the projections 104 may be placed on a belt 102 not originally intended to be used therewith. A belt 102 so modified may be utilized to provide tactile input as discussed above and may or may not include the electrically powered signaling device 114 as discussed above.

The apparatus 100 operates by providing tactile input to certain muscles which generates a signal to the brain improving the connection between the two and facilitating the contraction of the specific muscle and/or muscle groups. This tactile input enables the user to discern the particular muscles which are to be contracted, and in the course of dynamic or ongoing movement, improve the timing, coordination and effectiveness of the muscular contractions. This timing and coordination of contractions may be compared to predetermined ideal norms which have been established as desirable, and allow the person to make appropriate changes when required.

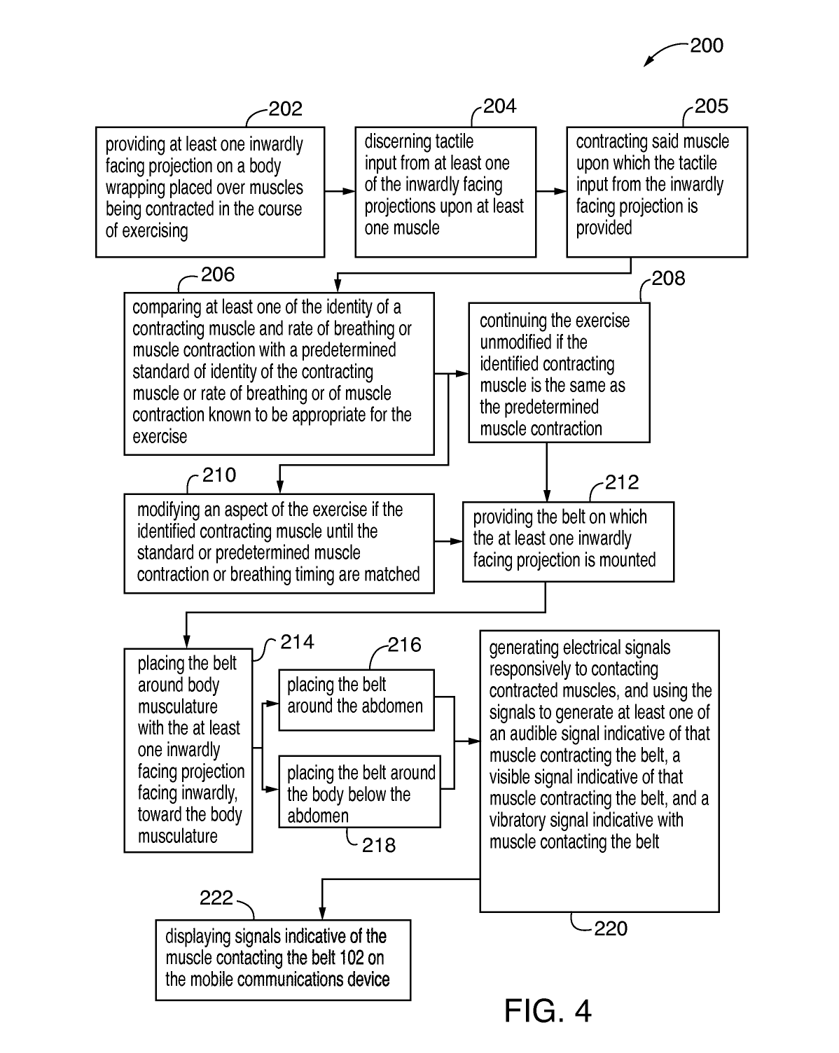

Therefore, and referring to FIG. 4, the invention may be thought of as a method 200 of improving coordinated muscular contractions necessary for all purposeful movement, especially those necessary for proper trunk stabilization. The method 200 includes a step of providing at least one inwardly facing projection 104 on a body wrapping (such as the belt 102) placed over muscles being contracted in the course of exercising (block 202); discerning tactile input from at least one of the inwardly facing projections upon at least one muscle (block 204); and contracting said muscle upon which the tactile input from the inwardly facing projection is provided (block 205). The method 200 may also include comparing at least one of identity of a contracting muscle or muscle contraction with a predetermined standard of identity of the contracting muscle or of muscle contraction known to be appropriate for the exercise (block 206). If the muscle contractions are in accord with their predetermined counterparts, or standards, the method 200 comprises continuing the exercise unmodified if the identified contracting muscle is the same as the predetermined muscle contraction (block 208). If, however, if the identified contracting muscle is different from the predetermined muscle contraction, the method 200 comprises modifying an aspect of the exercise until the standard or predetermined muscle contraction are matched (block 210).

In the method 200, providing at least one inwardly facing projection on the body wrapping may include providing the belt 102 on which the at least one inwardly facing projection 104 is mounted (block 212). The method 200 may further include placing the belt 102 around body musculature with the at least one inwardly facing projection 104 facing inwardly, toward the body musculature (block 214).

Because different parts of the body will benefit from the input provided by the present invention for better coordinated muscle contraction, placing the belt 102 around body musculature may comprise placing the belt 102 around the abdomen (block 216); or alternatively, placing the belt 102 around body musculature may comprise placing the belt 102 around the body below the abdomen (block 218).

The method 200 may comprise generating electrical signals responsively to contacting contracted muscles, and using the signals to generate at least one of an audible signal indicative of that muscle contacting the belt 102, a visible signal indicative of that muscle contacting the belt 102, and a vibratory signal indicative of that muscle contacting the belt 102 (block 220).

The method 200 may comprise displaying signals indicative of the muscle contacting the belt 102 on the mobile communications device 124 (block 222).

The above described apparatus and method(s) may be utilized for the user to contract and coordinate appropriate muscles. Proper diaphragm function, both respiratory and postural, and coordination, timing, and muscle activity (i.e., contractions) of movement patterns necessary for all movement may be promoted. Improving these patterns in turn improves effective body movement when exercising, stability, strength, and other body functions associated with or benefited by proper muscle coordination. Notably, appropriate muscle contractions protect and stabilize the spine. This holds true not only for simple exercises, but for advanced exercises, walking, lifting, and the like.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

1. A method of providing one or more sensible tactile inputs to specific targeted muscles which improves sensory awareness of the muscles and enables a person to improve coordination and strength of the muscular contractions produced during a physical activity, including exercising, the method comprising the steps of:
providing a body wrapping having elastic properties and having a body side and an exterior side, at least one inwardly facing projection adjutstably attachable along said body side of said body wrapping;
positioning the body wrapping around body musculature with the at least one inwardly facing projection facing the body musculature;
adjusting the at least one inwardly facing projection to a desired location on the body wrapping to provide the one or more sensible tactile inputs to the targeted muscles prior to the person performing the physical activity; and,
contracting said targeted muscles by the person during the physical activity into one or more of the tactile inputs provided by the inwardly facing projections.

2. (canceled)

3. The method of claim 1, wherein said at least one of said inwardly facing projections is substantially semi-spherical.

4. The method of claim 3, wherein said at least one of said inwardly facing projections is of an elastomeric composition.

5. The method of claim 3, further comprising comparing at least one of identity of a contracting muscle or muscle contraction with a predetermined standard of identity of the contracting muscle or muscle contraction known to be appropriate for the physical activity.

6. The method of claim 5, further comprising continuing the physical activity unmodified if the identified contracting muscle is the same as the predetermined muscle contraction, or modifying an aspect of the physical activity if the identified contracting muscle is different from the predetermined muscle contraction.

7. The method of claim 1, further comprising adding sensors to the projections to provide electrical signals responsively to the contracting of said targeted muscles.

8. The method of claim 1, further comprising displaying signals indicative of the targeted muscle contracting on a mobile communications device.

9. Apparatus for providing one or more sensible tactile inputs prior to contraction of a muscle to enable a person to better feel and coordinate contraction of said muscle during a physical activity, the apparatus associated with an at least partially elastic body wrapping having a body side and an exterior side, the apparatus consisting essentially of:
a plurality of inwardly facing projections associated with the body wrapping, wherein said projections are movably adjustable to be positioned along said body wrapping, wherein said projections are movably adjustable to be positioned along said body wrapping, wherein said projections are located on the body side of said body wrapping;
wherein each one of the projections includes:
a transducer;
an electrically powered signaling device; and
a power circuit including a power source operably connecting each one of the projections to the electrically powered signaling device;
a radio frequency transmitter in communication with each one of the transducers;
a mobile communications device responsive to the radio frequency transmitter, wherein said mobile communications device comprising:
a data processor;
a display in communication with the data processor;
a memory in communication with the data processor; and,
computer instructions loaded into the memory and operable to generate an output on the display wherein said output is indicative of at least one muscle actuating the transducer.

10. (canceled)

11. (canceled)

12. (canceled)

13. (canceled)

14. (canceled)

15. (canceled)

16. (canceled)

17. The method of claim 3, wherein each one of the projections comprises two or more mutually movable parts arranged to slide along one another as said muscle contracts.

18. The method of claim 3, wherein each one of the projections provides various degrees of resistance when a predetermined level of pressure is exerted on said inwardly facing projections by contraction of said muscle.

19. Apparatus for providing sensible tactile input to enable a person to improve coordination and contraction of at least one targeted muscle during a physical activity, the apparatus comprising:
a body wrapping with elastic properties having a body side and an external side; and,
a plurality of inwardly facing projections, wherein said projections are adjustably attachable upon said body side of said body wrapping, such that said projections are positioned to provide sensible tactile input to said targeted muscle in order to assist in improving the coordinated contraction of the muscle during a physical activity.

20. The apparatus of claim 19, wherein each one of the projections is substantially semi-spherical.

21. The apparatus of claim 20, wherein each one of the projections comprises two or more mutually movable parts arranged to slide along one another as said muscle distends.

22. The apparatus of claim 20, wherein each one of the projections provides various degrees of sensible resistance when a predetermined level of pressure is exerted on said body wrapping due to contraction and distension of said targeted muscle.

23. The apparatus of claim 20, wherein each one of the projections is of an elastomeric composition.
